(19) United States
(12) Patent Application Publication
(10) Pub. No.: US 2010/0215545 A1
(43) Pub. Date: Aug. 26, 2010

(54) BIOCHEMICAL MEASURING DEVICE

(76) Inventors: Toshio Yoshida, Tokyo (JP); Kenichi Tayama, Tokyo (JP); Michio Taira, Tokyo (JP); Tomoyasu Nagata, Tokyo (JP); Kiyohide Maguchi, Niigata (JP)

Correspondence Address: MATTINGLY & MALUR, P.C., 1800 DIAGONAL ROAD, SUITE 370, ALEXANDRIA, VA, 22314, US

(21) Appl. No.: 11/849,511

(22) Filed: Sep. 4, 2007

(30) Foreign Application Priority Data
Sep. 5, 2006 (JP) 2006-240796

(51) Int. Cl. G01N 21/00

(52) U.S. Cl. 422/82.11

(57) ABSTRACT

A fiber switching mechanism of a lighting system for passing a light through one of n optical fibers corresponding to n channels sequentially is provided midway in n optical fibers of the lighting system corresponding to n channels such that lights from n optical fibers of a receiving system can be commonly received by a single spectroscope. With the fiber switching mechanism of the lighting system, it is possible to obtain measuring data of reflection spectrum of n optical thin film sensor portions by the single spectroscope.

### TECHNICAL FIELD

This invention relates to a biochemical measuring device and, in particular, this invention relates to an improvement of a biochemical measuring device which is suitable in a measurement using a multi-channel measuring sensor chip for measuring coupling of biochemical substances due to such as antibody reaction in a plurality of channels, is inexpensive and is capable of being made compact.

### BACKGROUND ART

The chemical sensor utilizing optical interference color of an optical thin film has been known. When the thickness of the optical thin film is one fourth or odd times of one-fourth of wavelength of a visible light and the sensor is irradiated with the visible light, a reflection spectrum having a peak at which an intensity of light reflected in a vertical direction from the thin film becomes substantially zero is produced and, according to the reflection spectrum, the sensor produces a predetermined interference color as a reflected light.

For example, when a unimolecular layer of ligand (functional group) is provided on the thin film of the sensor as a biochemical substance (probe), the position of peak wavelength at which intensity of the reflected light is substantially reduced in the reflection spectrum of the sensor is shifted correspondingly to the increased thickness due to the unimolecular layer. When a sample (such as protein to be tested) adheres onto the ligand unimolecular layer further, the position of peak wavelength is shifted due to the further increase of thickness of the thin film, so that the interference color is changed and the reflection spectrum is changed. Therefore, the sensor can measure the adhesion of the sample (such as protein to be tested) onto the optical thin film by the interference color or the reflection spectrum.

As another chemical sensor for measuring coupling of biochemical substance such as antibody reaction, a sensor chip which has an optical thin film provided on a silicon substrate and biochemical substance (probe) provided on the optical thin film has been known. Further, there is another chemical sensor in which a sensor chip is formed by adhering ligand such as carboxyl methyl dextran to a surface of a gold optical thin film as a biochemical substance (probe) and a change of refractive index of the surface of the sensor chip is measured by resonating vibration phenomenon of the gold surface plasmon with light.

The sensor chip using the surface plasmon reflects light inputted through a prism correspondingly to coupling or coupling and decoupling of the ligand and a sample (protein to be tested). Energy of the reflected light is vanished at a specific angle. The energy varnishing at the specific angle is detected as a valley (peak), in which intensity of reflected light is attenuated, by a measuring device through the prism. Further, the peak is used as SPR angle (varnishing angle) and a time-change of mobility (peak shift) of the SPR angle is measured.

Incidentally, when the coupling or the coupling and decoupling of two molecules is measured, it is necessary to feed liquid to a flow-cell forming a fluid channel of the sensor chip at a constant flow rate.

The sensor chip having the optical thin film of gold is expensive and the adhesion of ligand to the optical thin film is not easy. In another known sensor chip, an optical thin film is formed by forming a silicon nitride (SiN) film on a silicon substrate in order to facilitate adhesion of ligand to the optical thin film and optical interference color is utilized. In a measuring device which utilizing this sensor chip, an interference spectrum is obtained by irradiating the sensor chip with light and analyzing wavelength of reflected light which is interfered by the optical thin film and the coupling or the coupling and decoupling of samples is measured as a peak shift of the interference spectrum waveform.

Incidentally, a sensor chip having a metal thin film formed on a glass substrate which utilizes optical interference color is known (Patent Publications 1 and 2). Further, a micro fluid device having a sensor chip in which channel flow passage is formed and feeds fluid through the channel flow passage during measurement is known (Patent Publication 3).

[Patent Publication 1] JP-A-2004-132799

[Patent Publication 2] JP-A-2005-321196

[Patent Publication 3] JP-A-2005-181095

In order to measure time-change of the peak shift of the reflected light due to optical interference of the optical thin film, it is necessary to measure spectrum of the reflected light, which is obtained from the sensor chip with high preciseness. In order to realize this, an average value of results of measurement for a number of optical thin film regions of the sensor chip by a multi-channel light receiver provided in the sensor chip is calculated and, in order to obtain the peak wavelength, the attenuation curve of the reflected light spectrum is closely resembled by approximation by means of such as the method of least squares, as described in Patent publications 1 and 2. By using a multi-channel sensor chip, it is possible to measure couplings of biochemical substances in the respective channels of the sensor chip.

However, in the sensor chip described in each of Patent Publications 1 and 2, the sensor chip capable of performing 4-channel measurement requires 4 spectroscopes because the reflected lights from the respective optical thin films are independent and, in order to analyze the reflection spectrum, the reflected light can not be mixed as they are.

As a result, the size of the biochemical multi-channel measuring device is increased and the cost of the device is increased due to the expensive spectroscopes. Further, when the translucent sensor chip measures multi-channels at one time, lights leaks between channels mutually, resulting in degraded measuring preciseness.

The sensor chip for measuring the peak shift requires an input and output ports for buffer solution since the measurement is performed while flowing the buffer solution as described in Patent Publications 1 and 2. Therefore, the sensor chip can not irradiate the optical thin film sensor portion and can not receive the reflected light from the optical thin film sensor portion unless the input port and the output port are provided in locations different from the optical thin film sensor portion. However, when the input ports and the output ports are provided independently as described in Patent Publications 1 and 2, the size of the sensor chip itself become large, resulting in a treating problem of the sensor chip.

### SUMMARY OF THE INVENTION

An object of this invention is to provide a biochemical measuring device which is inexpensive and can be miniaturized and used with a sensor chip for multi-channel measurement.

In order to achieve this object, the biochemical measuring device according to this invention is constructed with a sensor chip having n optical thin film sensor portions (n being an integer not less than 2), n optical fibers of a light system for irradiating the optical thin film sensor portions respectively, an optical fiber switching mechanism of a lighting system provided in midways of the n optical fibers of the lighting system, for selectively allowing light of one of the n lighting optical fibers to pass and cutting off remaining lights of the remaining optical fibers, n optical fibers of a receiving system for receiving respective reflected lights from the n optical thin film sensor portions, a spectroscope for commonly receiving the reflected lights from the n optical fibers of the receiving system and a control portion for selecting an irradiating light from arbitrary one of the optical fibers of the lighting system by controlling the optical fiber switching mechanism of the lighting system, wherein the reflected light from the optical thin film sensor portion lighted by the selected optical fiber of the lighting system is spectrally analyzed.

In the present invention in which the optical fiber switching mechanism of the lighting system is provided in midways of the n optical fibers of the lighting system, for selectively allowing light to pass through one of the n optical fibers of the lighting system sequentially, it is possible to obtain the measuring data of the reflection spectrum of the n optical thin film sensor portions by the single spectroscope correspondingly to the switching of the optical fibers of the lighting system. Incidentally, each of the n optical fibers of the lighting system may be a bundle of a plurality of optical fibers.

When the spectroscope is of the diffraction grating type, it becomes possible to arrange the n receiving optical fibers of the receiving system along input side slits of the spectroscope by setting a diameter of each of the n optical fibers of the receiving system for guiding reflection lights to 1/n of the length if input side slit of the diffraction grating type spectroscope. Therefore, it is possible to obtain measuring data for n channels time-divisionally by a single spectroscope by sequentially selecting the optical fibers of the lighting system according to time-divisional switching of the optical fiber switching mechanism of the lighting system and sequentially obtaining an output of the diffraction grating type spectroscope time-divisionally.

In a case where a spectroscope receiving one input light is used, the optical fiber switching mechanism for the receiving system is provided to input light to the spectroscope by selecting one of the n optical fibers of the receiving system.

Therefore, it is possible to use a light transmission sensor chip having n micro-channels as the sensor chip. An n-channel sensor chip which is formed by adhering an opposing substrate which is a silicon rubber having n micro-channels formed by, for example, PDMS (Polydimethylsiloxane) to a silicon substrate having optical thin film of silicon nitride formed by a semiconductor processing may be used as the transmission sensor chip. Further, when pods are provided in opposite ends of each micro-channel of the sensor chip and connected to the liquid input port and the output port, respectively, it is possible to reduce thickness of the sensor chip. Therefore, it is possible to restrict the size of the sensor chip and the handling thereof becomes easy. Incidentally, the optical thin film sensor portion is provided by providing biochemical substance such as ligand on the optical thin film as a probe.

Since only one optical fiber is required by the optical fiber switching mechanism of the lighting system even when the transmission sensor chip formed by PDMS is used, there is no leakage of light between channels. Therefore, preciseness of measurement is not reduced.

As a result, a biochemical measuring device which can be made compact, is inexpensive and is suitable as a sensor chip for multi-channel measurement can be realized.

### BRIEF DESCRIPTION OF THE DRAWINGS

FIG. 1 is a block diagram of a biochemical measuring device according to an embodiment of the present invention,

FIG. 2(a) is a plan view of a sensor chip having two micro-channels,

FIG. 2(b) is a cross section taken along a line A-A in FIG. 2(a),

FIG. 3 is a side view of a measuring stage of the sensor chip,

FIG. 4 is a front view of a 2-channel lighting optical fiber switching mechanism of a lighting system,

FIG. 5 illustrates an arrangement of optical fibers and receiving optical fibers of the lighting system in an input side slit of a diffraction grating type spectroscope,

FIGS. 6(a)-6(c) are cross sections of optical fiber bundles of a lighting system and a receiving system,

FIGS. 7(a)-7(b) show explanatory graphs of interference spectrum and a peak shift of reflected light,

FIG. 8 shows an 8-channel optical fiber switching mechanism of the lighting system,

FIG. 9(a) is a plan view of an optical fiber switching mechanism of the receiving system in another embodiment of the present invention,

FIG. 9(b) shows an arrangement of optical fibers of the optical fiber switching mechanism of the receiving system,

FIG. 9(c) shows an arrangement of optical fibers of the optical fiber switching mechanism of the receiving system on the side of the spectroscope, and

FIG. 10 shows waveforms of signals for switching the optical fiber switching mechanism of the lighting system and the optical fiber switching mechanism of the receiving system.

### DESCRIPTION OF THE PREFERRED EMBODIMENTS

In the drawings, similar constructive elements are depicted by the same reference numerals, respectively.

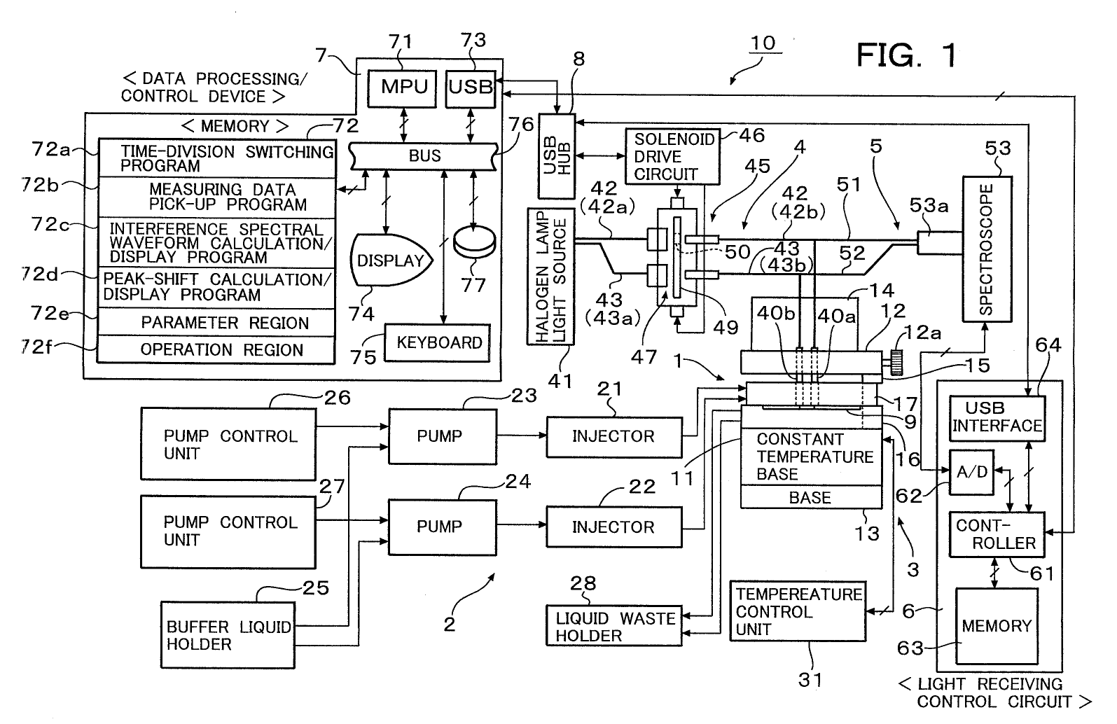

In FIG. 1, a reference numeral 10 depicts a biochemical measuring device. The biochemical measuring device 10 is constructed with a measuring stage 1, a liquid feeding system 2, a temperature regulating system 3, a lighting system 4, a light receiving system 5, a light receiving control circuit 6, a data processing/control device 7 and a USB hub 8, etc., and measures coupling or coupling/decoupling of biochemical substance in a sensor chip 9.

The measuring stage 1 includes a sensor chip mounting table 16 mounted on a constant temperature base 11 of the temperature regulating system 3, a chip cover 17 provided thereon and a movable table 12 provided above the chip cover 17.

The movable table 12 supports two optical fiber bundles of a lighting system and two optical fibers of a receiving system and the constant temperature base 11 keeps temperature of the sensor chip 9 at a predetermined temperature.

The movable table 12 is movable vertically and is mounted on an upright bracket 14 on a base 13 through an elevator mechanism (not shown) behind the measuring stage 1. A reference numeral 15 depicts a stopper bar planted in the base 13 for restricting a downward movement of the movable base 12. The movable base 12 has a regulation knob 12a for finely regulating a stopping position of the movable base 12 with respect to the stopper bar 15. As a result, it is possible to finely regulate positions of top ends (bundle tubes 40a, 40b) of the optical fibers of the lighting and receiving systems with respect to the sensor chip 9 (optical thin film sensor portion).

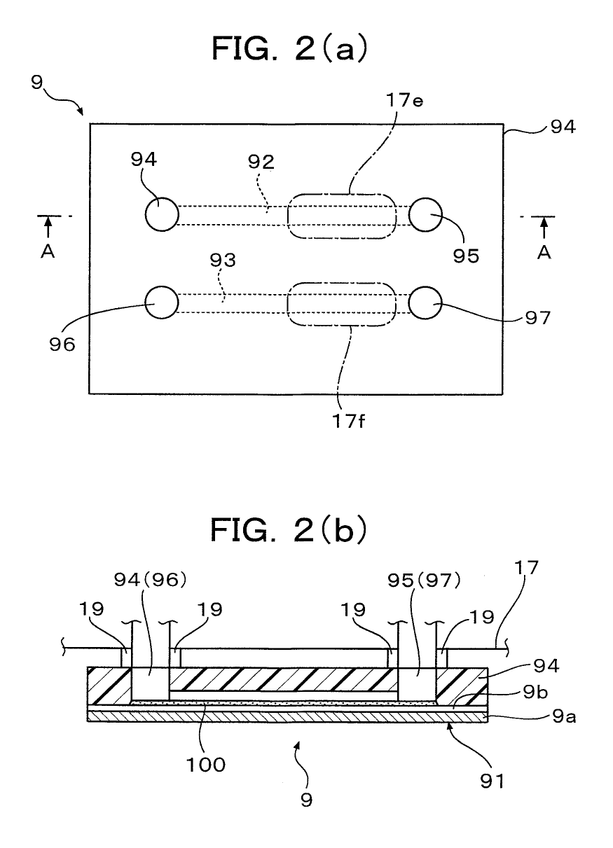

The sensor chip 9 is a micro-chip having two liquid channels. As shown in the plan view in FIG. 2(a) and the A-A cross section shown in FIG. 2(b), the sensor chip 9 includes a base 91, which is an optical thin film 9b formed of a silicon nitride (SiN) film formed on a surface of a silicon substrate 9a through a semiconductor forming process, and an opposing substrate 94 having at least 2 micro-channels 92 and 93 and formed by PDMS is adhered to the base 91. The silicon substrate 9a is 0.7 to 0.8 mm thick and the optical thin film 9b is several hundreds nm thick.

Pods 94 to 97 having upper portions opened are provided in opposite ends of the micro-channels 92 and 93. The opened upper portion of each pod is rectangular and an area thereof is in a range from 15 mm×20 mm to 20 mm×30 mm.

As shown in FIG. 3, the sensor chip 9 is mounted on the measuring stage 1. A recessed portion 16a having an area slightly larger than the sensor chip 9 is formed in the sensor chip mounting table 16 of the measuring stage 1. The sensor chip 9 is positioned in the recessed portion 16a. A member for positioning the sensor chip 9 is not shown.

The chip cover 17 is arranged below the movable base 12 and above an upper portion of the sensor chip 9 by a predetermined distance. As shown in FIG. 3, the chip cover 17 is moved down onto the sensor chip 9.

As shown by dotted lines in FIG. 3, the chip cover 17 has an input port 17a and an output port 17c which are bent at right angles such that vertical portions of the ports correspond to the opposite end portions of the micro-channel 92 to form clank-shaped communication passages. An input port 17b and an output port 17d are formed similarly to the input ports 17a and 17b in FIG. 2(a)

The openings of the input ports 17a and 17b are positioned correspondingly to the positions of the pods 94 and 96 of the sensor chip 9 positioned on the sensor chip mounting table 16 and the openings of the input ports 17c and 17d are positioned correspondingly to the positions of the pods 95 and 97 of the sensor chip 9, similarly.

Incidentally, the chip cover 17 may be formed by PDMS or SUS or other member which does not influence on the measurement may be used therefor.

The input ports 17a and 17b and the output ports 17c and 17d have funnel-shaped connector portions 18 provided in respective side portions of the chip cover 17. The respective input and output ports are connected to injectors 21 and 22 shown in FIG. 1 through the connector portion 18 and conduits.

The pods 94 and 96 are connected to the injectors 21 and 22 and filled with predetermined amounts of liquid supplied through the input ports 17a and 17b. Then, the liquid flows through the micro-channels 92 and 93 to the pods 95 and 97, respectively. Further, the liquid is sent from the pods 95 and 97 to a waste holder 28 through the output ports 17c and 17d.

As shown by dotted lines in FIG. 2(b), seal rings 19 protruding downward to the pods 94 to 97 are provided as flanges. With these flanges, leakage of the liquid from the injectors 21 and 22 and the liquid from the pods 95 and 97 is prevented.

Incidentally, the chip cover 17 is pushed onto the surface of the sensor chip 9 with a constant pressure by means of a pressing mechanism which is not shown.

As shown in FIG. 2(a), rectangular holes 17e and 17f are provided in the hip cover 17. The holes 17e and 17f are positioned in the upper portions of the micro-channels 92 and 93, as shown by chain-lines in FIG. 2(a). Bundle tubes 40a and 40b (FIG. 3) are inserted into the rectangular holes 17e and 17f, respectively. Although the bundle tubes are in parallel in FIG. 1, these tubes are practically overlapped as shown in FIG. 3.

Each of the top end portions of the optical fibers of the lighting system and the receiving system, which are opposing to the sensor chip 9, constitutes the bundle 40a (40b) having diameter of 2 mm as shown in FIG. 6(c) and the bundle tubes 40a and 40b are fixedly inserted through the holes 17e and 17f of the movable table 12 as shown in FIG. 1, with the top end portions of the bundle tubes 40a and 40b being arranged in the holes 17e and 17f, respectively. The positions of the top end portions of the bundle tubes correspond to the upper portion of the micro-channels 92 and 93, respectively.

As shown in FIG. 2(b), an optical thin film sensor portion 100 is formed on the surface of the optical thin film 9b of silicon nitride (SiN) in which the pods 94 to 97 and the respective micro-channels 92 and 93 are formed. The optical thin film sensor portions 100 are formed by accumulating buffer liquid containing ligand in the buffer liquid holder 25, filling the pods 94 and 96 with buffer liquid through the input ports 17a and 17b of the sensor chip 9 and feeding the buffer liquid to the respective micro-channels 92 and 93.

The optical thin film 9b comprises one of SiN, SiN+amino radical, SiN+epoxy radical, SiN+carboxyl radical or the like and the optical thin film sensor portion 100 is a ligand which adheres onto the surface of that optical thin film 9b and the sensor chip 9 having the thus formed optical thin film sensor portion 100 is supplied.

In the following description, it is assumed that the optical thin film sensor portion 100 is preliminarily formed in each of the pods 94 to 97 and the micro-channels 92 and 93.

Returning to FIG. 1, the liquid feeding system 2 is controlled by the data processing/control device 7 and comprises the injectors 21 and 22, pumps 23 and 24, the buffer liquid holder 25, pump control units 26 and 27 and the liquid waste holder 28.

The pump control units 26 and 27 suck up a predetermined amount of the liquid from the buffer liquid holder 25 by driving the pumps 23 and 24 and supply the liquid to the injectors 21 and 22 through conduits connected thereto.

The injectors 21 and 22 supply a predetermined amount of liquid to the pods 94 and 95 through the conduits connected to the input ports 17a and 17b.

The temperature regulation system 3 comprises the constant temperature base 11 and a temperature control unit 31 and regulates the temperature of the constant temperature base 11 under control of the data processing/control device 7 such that the sensor chip 9 becomes an aimed temperature.

The lighting system 4 comprises a halogen lamp light source 41 and two optical fiber bundles 42 and 43 and irradiates the micro-channels 92 and 93 of the sensor chip 9 with light from the light source 41.

The optical filter bundles 42 and 43 are of the lighting system and each composed of 6 optical fibers 44 as shown in FIG. 6(b). The 6 optical fibers 44 of each of the optical fiber bundles 42 and 43 are arranged in an upper layer and a lower layer and the bundles are arranged vertically as shown in FIG. 6(a). Diameter of the optical fiber is 0.5 mm.

The bundles 42 and 43 are cut on the way to two bundle portions 42a and 42b and to two bundle portions 43a and 43b, respectively.

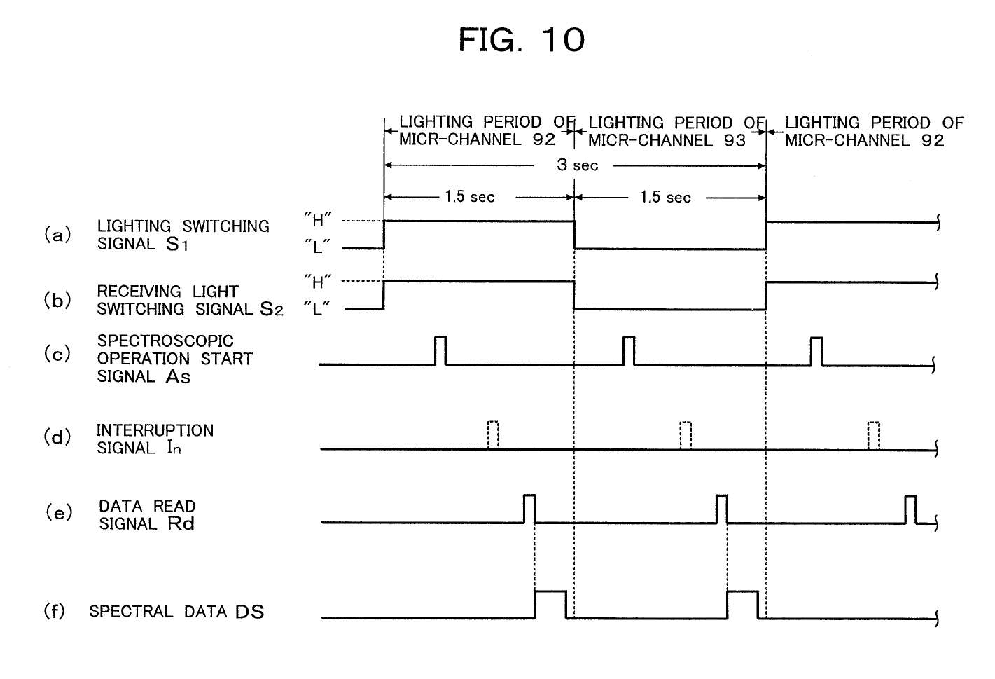

A 2-channel optical fiber switching mechanism 45 of the lighting system is provided between the bundle portions 42a and 42b and between the bundle portions 43a and 43b. The switching mechanism 45 functions to block one of the lights lighting the micro-channels 92 and 93 of the sensor chip 9 while passing the other. This switching operation is performed by driving a shutter mechanism 47 by a solenoid drive circuit 46 upon a lighting switch signal S1 (refer to FIG. 10(a)) supplied from the data processing/control device 7 through a USB interface 73 and a USB hub 8.

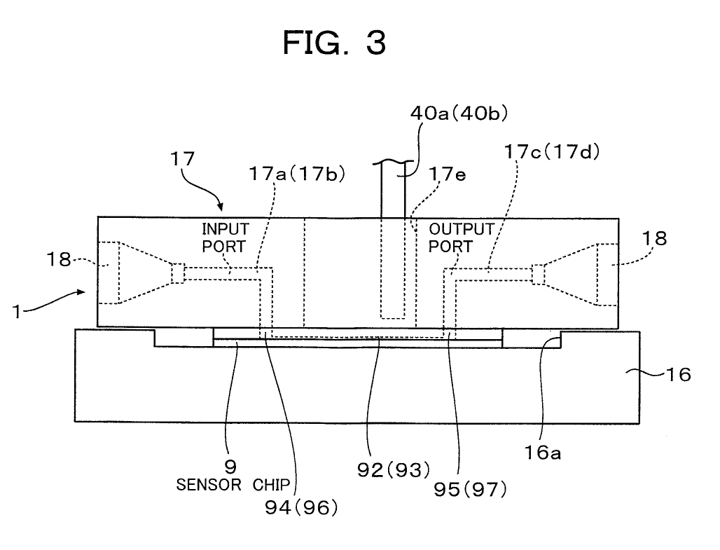

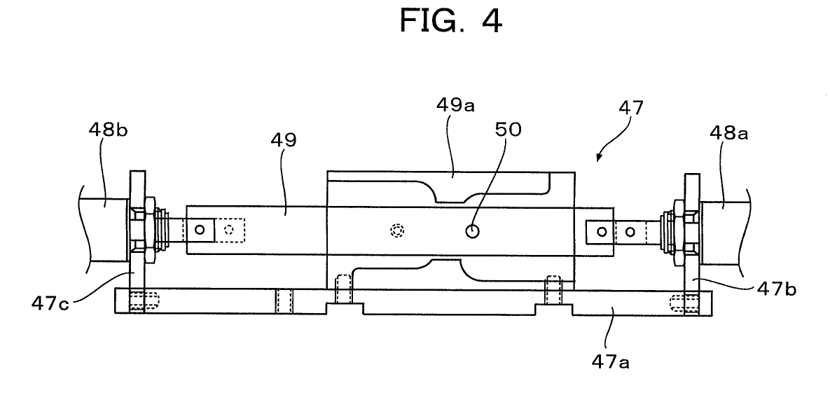

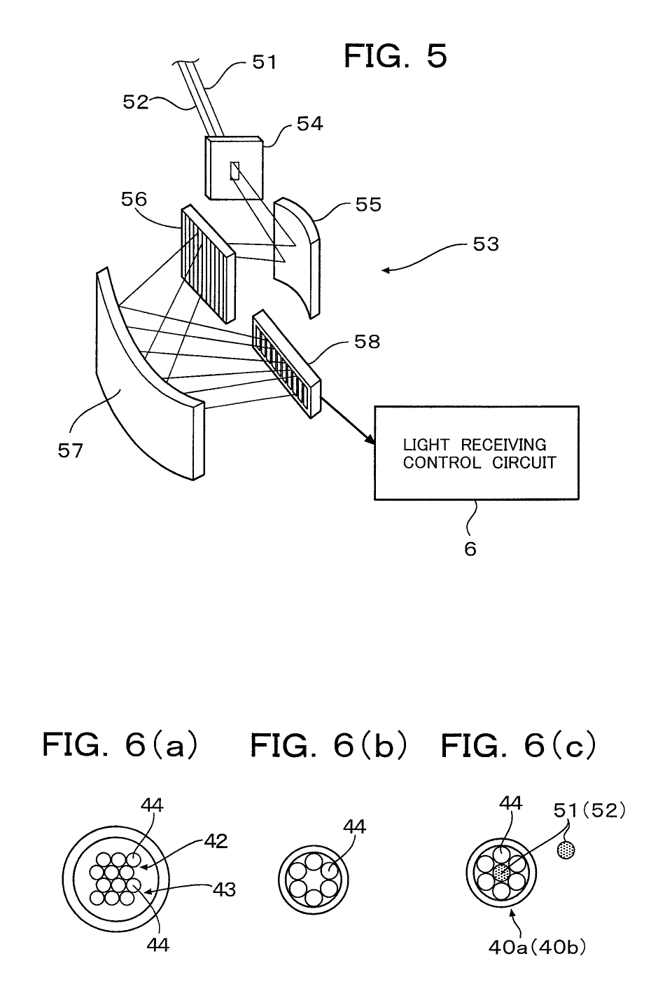

FIG. 4 is a front view of the 2-channel optical fiber switching mechanism 45 of the lighting system. The shutter mechanism 47 includes brackets 47b and 47c provided at opposite ends of a base plate 47a and solenoids 48a and 48b are fixed to the brackets 47b and 47c, respectively. The solenoids 48 and 49 have movable rods respectively and the rods are bridged by a shutter plate 49. Incidentally, a reference numeral 49a depicts a pair of fixing plates for fixing the optical fiber bundles 42 and 43, which are provided on both sides of the shutter plate 49. The fixing plates 49a are fixed on the base plate 47a and have connectors for holding the respective optical fibers as shown in FIG. 1.

The fixing plates 49a of the shutter plate 49 fix the optical fibers such that centers of the bundle portions 42a and 42b and centers of the bundle portions 43a and 43b are mutually matched.

Incidentally, although the base plate 47a of the shutter mechanism 47 is positioned below the shutter plate 49 in FIG. 4, the positioning may be reversed.

The shutter plate 49 has a light passing hole 50. The shutter plate 49 is moved with the movement of the rod of one of the solenoids 48a and 48b by the solenoid drive circuit 46 such that the light passing hole 50 is moved to a position corresponding to the position of one of the optical fiber bundles 42 and 43 as shown in FIG. 1 to pass light through it. Incidentally, diameter of the light passing hole 50 is slightly larger than 2 mm, which is the diameter of the optical fiber bundle, and may be in the order of 3 mm.

The light receiving system 5 comprises optical fibers 51 and 52 and a spectroscope 53. As shown in FIG. 6 (c), top ends of the optical fibers 51 and 52, which are light receiving portions, are arranged at centers of the optical fibers 44 of the bundle tubes 40a and 40b and derived through the bundle tubes 40a and 40b, respectively.

The spectroscope 53 is of the transmission diffraction grating type and is provided with an input connecter 53a as shown in FIG. 1. The spectroscope 53 itself comprises a slit 54 which receives input light through the input connector 53a, a collimator mirror 55, a transmissive holographic grating 56, a focusing mirror 57 and one dimensional CCD image sensor (linear sensor) 58, etc.

The optical fibers 51 and 52 extending through the input connector 53a are arranged along a longitudinal direction of the slit 54. Width of the slit 54 is slightly larger than 0.5 mm which is the diameter of the optical fiber and length of the slit 54 is several millimeters which is enough to make a plurality of optical fibers possible to arrange along the longitudinal direction of the slits 54. Therefore, lights from the optical fibers 51 and 52 fall in the same position on the transmissive holographic grating 56 when looked in a vertical direction and fall in different positions on the transmissive holographic grating 56 when looked in a horizontal direction.

Wavelengths of the lights from the slit 54 are analyzed through the collimator mirror 55, the transmissive holographic grating 56 and the focusing mirror 57 and then falls on the CCD sensor 58 at reflection angles corresponding to respective wavelengths. The number of pixels of the CCD sensor 58 is 1024 and pixel width in a direction vertical to the arranging direction of the pixels is designed such that spectral light obtained by analyzing the output lights from the optical fibers 51 and 52 can be received by the pixels.

Returning to FIG. 1, the receiving light control circuit 6 comprises a controller 61, an A/D converter circuit 62, a memory 63 and a USB interface 64.

The controller 61 responds to the output signal from the data processing/control device 7 to read 1024 pixels obtained by the CCD sensor 58 of the spectroscope 53, converts the 1024 pixels into a digital value by the A/D converter circuit 62 of such as 16 bits and stores the digital value in the memory 63 correspondingly to positions of the detected pixels.

Incidentally, the positions of the respective pixels correspond to wavelengths of the analyzed spectral waveforms and the controller 61 receives an analysis start signal AS (FIG. 10(c)) from an MPU 71, reads spectrally analyzed data for one time from the CCD sensor 58 through the A/D converter 62 and stores it in the memory 63. When the storage of the data completed, an interrupt signal In (FIG. 10(d)) is generated in the data processing/control device 7. In this case, it may be possible to store a plurality of spectrally analyzed data groups, for example, 100 data groups, in the memory 63 by reading 100 data groups. Incidentally, the read-in of the spectrally analyzed data from the CCD sensor 58 by the controller 61 is performed after a predetermined time, for example, 1.1 sec, from the starting timing of the light switching signal S1 (rising or falling timing in FIG. 10(a)).

The USB interface 64 transfers the receiving data (for one or plural data groups of the spectrally analyzed data) stored in the memory 63 to the data processing/control device 7 by controlling the processing/control device 7.

The data processing/control device 7 may be a usual personal computer having a USB terminal, the MPU 71, the memory 72, the USB interface 73, a display 74, a keyboard 75 and a bus for connecting these components. Upon the interrupt signal In from the controller 61, the data processing/control device 7 obtains the measuring data (spectrally analyzed data) in the memory 63 through the USB interfaces 64 and 73 and stores it in a predetermined region of the memory 72. Incidentally, a reference numeral 77 depicts an external memory device such as HDD or the like.

A time-division switching program 72a, a measuring data pick-up program 72b, an interference spectral waveform calculation/display program 72c and a peak-shift calculation/display program 72d, etc., are stored in the memory 72. The memory 72 further includes a parameter region 72e and an operation region 72f.

The time-division switching program 72a is executed by the MPU 71 according to a key input of a measurement start function from the keyboard 75 or according to a call during an execution of any other program. The MPU 71 executes the time-division switching program 72a to drive the 2-channel optical fiber switching mechanism 45 of the lighting system such that the lights from the optical fiber bundles 41 and 42 are switching alternately with intervals of 1.5 seconds (refer to the light switching signal S1 in FIG. 10(a)) to alternately irradiate the micro-channels 92 and 94 of the sensor chip 9 to thereby store the spectrally analyzed data obtained from the spectroscope 53 such as data for 100 groups in the memory 63 of the control circuit 6 of the receiving system correspondingly to the irradiation periods of the optical fibers 41 and 42.

The measuring data pick-up program 72b is executed by the MPU 71 according to a key input of a predetermined function from the keyboard 75 or a call during the execution of another program. Upon the execution of this program, the MPU 71 drives the liquid feed system 2 through the data processing/control device 7. Incidentally, buffer liquid for diluting a sample is accumulated in the buffer liquid holder 25. The buffer liquid is fed to the micro-channels 92 (a first channel) and the micro-channel 93 (a second channel) by the execution of this program. Simultaneously with this operation, the data read signal Rd (FIG. 10(d)) is supplied to the controller 61 according to the interrupt signal In from the controller 61 after the predetermined time from the switching time of the light switching signal S1 (FIG. 10(a)) of the optical fiber switching mechanism 45 of the lighting system, so that the spectrally analyzed data (measured data) for 100 groups of relected lights in the micro-channel 92 (corresponding to the first channel) and the micro-channel 94 (corresponding to the second channel) are read from the memory 63 of the control circuit 6 alternately through the USB interface 64 and stored in the memory 72 every switching of the optical fiber switching mechanism 45 of the lighting system due to the lighting switching signal S1. The spectral data of the reflection lights in the respective optical thin film sensor portions 100 are stored in memory positions corresponding to the respective channels of the working area 72f and the MPU 71 calls the interference spectral waveform calculation/display program 72c.

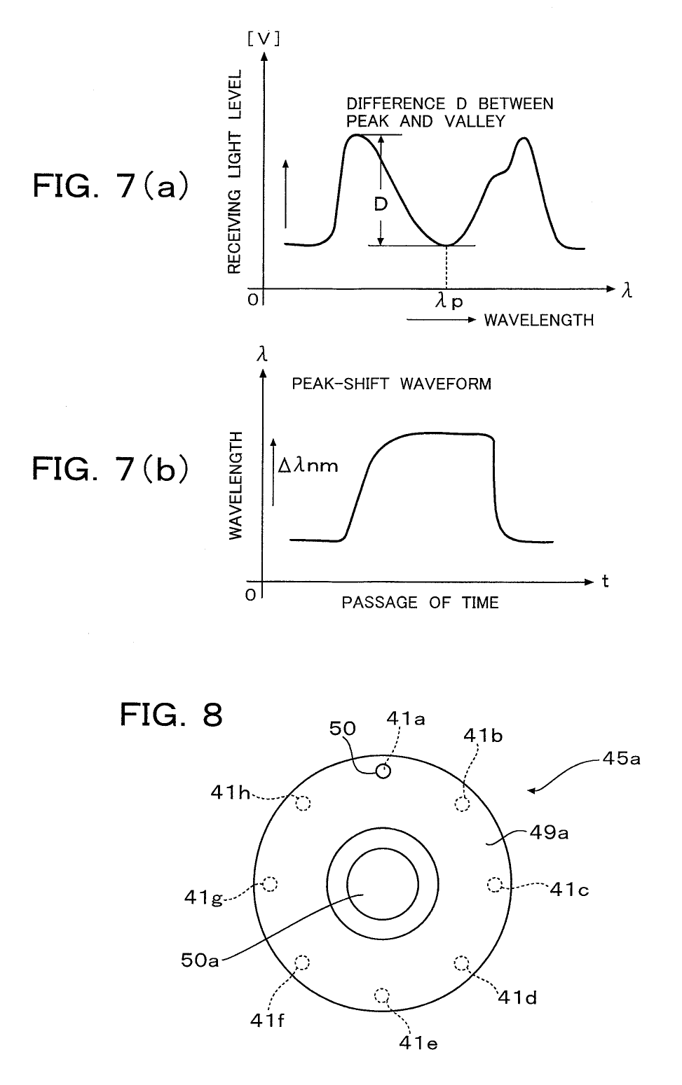

The interference spectral waveform calculation/display program 72c is called by another call at the time when the execution of the measured data measuring data pick-up program 72b is ended or a key input of a spectral waveform data display function from the key board 75 and executed by the MPU 71. The MPU 71 produces the waveform data by averaging the spectral data for a total of 200 groups corresponding to the analyzed wavelength of the micro-channel 92 (first channel) and the micro-channel 93 (second channel) and displays the interference spectral waveform such as shown in FIG. 7(a) on the display 74 in which the receiving light level (voltage) is plotted on the ordinate and the wavelength on abscissa.

Since the interference spectral waveform is measured while the buffer liquid for diluting the sample is being fed, it is the interference waveform with respect to ligand. When the difference D between the peak and the valley of the interference spectral waveform is small, the top end of the optical fiber is separated from the chip surface or pushed into the chip surface. In such case, the correctness of position of the movable table 12 with respect to the stopper bar 15 is confirmed by regulating the position by the regulation knob 12a and displaying the interference spectral waveform again.

When the interference spectral waveform is correct, the peak-shift calculation/display program 72d is called by a key input of the measurement start function or a key input of a predetermined function and executed by the MPU 71. In this case, the sample is diluted by buffer liquid in the buffer holder 25.

The measurement of the sample is started by the liquid feed system 2 to supply the sample from the injectors 21 and 22 to the pods 94 and 95, respectively, and, then, calls the time-division switching program 72a and the measured data pick-up program 72 and executes these programs in parallel by the task processing. The predetermined amount of liquid are fed to the micro-channel 92 (first channel) and 94 (second channel) at a predetermined flow rate and the spectral data of reflection lights from the optical thin film sensor portions 100 formed in the micro-channel 92 (first channel) and 94 (second channel) are stored in the work region 72f of the memory 72 correspondingly to the respective channels. Incidentally, the interference spectral waveform calculation/display program 72c is not called.

Further, the MPU 71 calculates an amount of change of wavelength Λp at the peak (valley of reflection light) in each channel on the basis of the spectral data of 200 groups corresponding to the respective channels stored in the work region 72f of the memory 72 with passage of time.

In concrete, the MPU 71 detects the wavelength Λp (FIG. 7(a)) at the peak position by averaging a number of spectral data of the first and second channels, which are stored in the work region 72f in predetermined times with intervals of 1.5 sec, in every measuring time with intervals of 3 sec, calculating a coefficient of Voight function by the least squares method and performing the fitting processing of the respective spectral waveform data by Voight function. Further, data of change of peak wavelength vs. time is produced by calculating the difference of wavelength DΛ=Λpi−Λpo from the respective spectral waveform data wavelength Λpi (where Λpo is wavelength Λp at the peak position at the measurement start time point) and displays the peak-shift waveform shown in FIG. 7(b) on the display 74 with wavelength change DΛ on ordinate and time on abscissa.

Incidentally, since the respective program processes are simple and can be understood by the above description, flowcharts thereof are omitted.

FIG. 8 shows an optical fiber switching mechanism for an 8-channel lighting system which has a rotary shutter disk 49a in lieu of the shutter plate 49 of the shutter mechanism 47 of the optical fiber switching mechanism 45 shown in FIG. 4. In lieu of the optical fiber bundles 41 and 42 shown in FIG. 1, 8 optical fiber bundles 41a to 41h are arranged in an outer periphery of the shutter disk 49a with intervals of 45° in the optical fiber switching mechanism 45a. A hole 50 is provided in a position of the outer periphery of the shutter disk 49a. The optical fiber switching mechanism 45a selectively irradiates one of the micro-channels of a sensor chip having 8 micro-channels by rotating the shutter disk 40a by 45° stepwise by the stepping motor 50a to select one of the optical fiber bundles 41a to 41h.

With this construction, it is possible to time-divisionally analyze the wavelength for the respective micro-channels of the sensor chip by a single spectroscope.

Incidentally, in this case, the light receiving system 5 has 8 light receiving optical fibers. Thus, in the spectroscope 53, it is enough to arrange the 8 light receiving optical fibers along the longitudinal direction of the slits 54 and determine the width of each pixel of the CCD sensor in the direction orthogonal to the arrangement of the pixels such that the pixels can receive the 8 light receiving optical fibers.

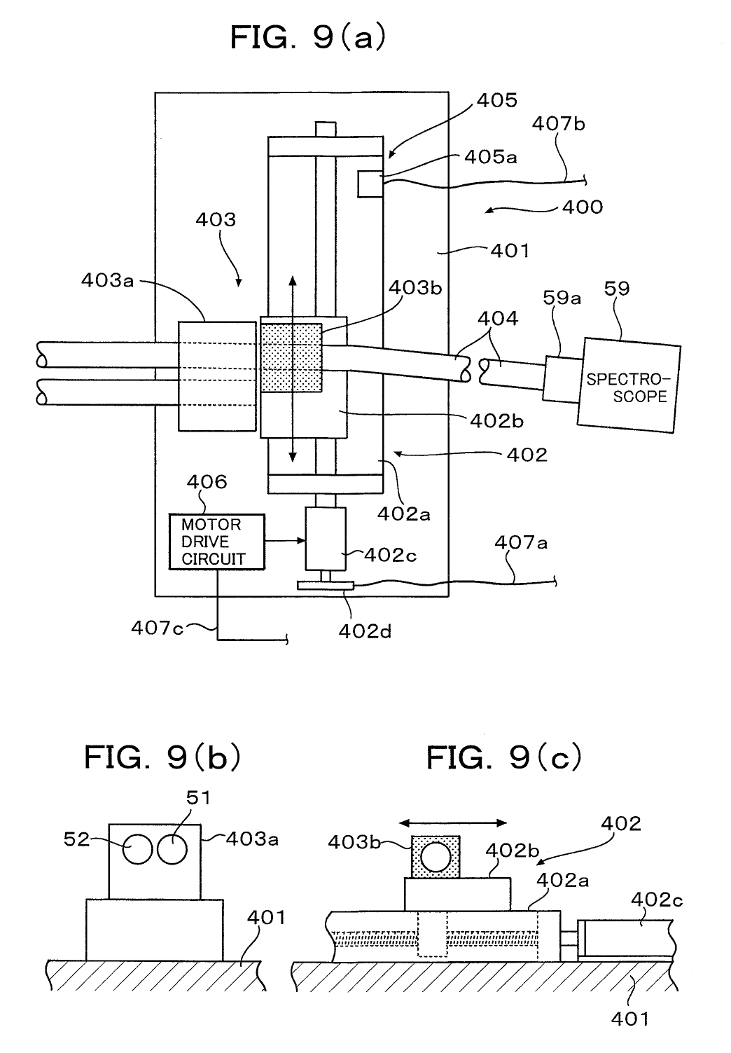

FIG. 9 shows another embodiment of this invention in which FIG. 9(a) is a plan view of the optical fiber switching mechanism of the light receiving system, FIG. 9 (b) shows an arrangement of the optical fibers of the lighting system and FIG. 9(c) shows an arrangement of the optical fibers on the side of the spectroscope of the optical fiber switching mechanism of the receiving system. Incidentally, since other constructions of this embodiment except the optical fiber switching mechanism of the receiving system are similar to those shown in FIG. 1, the description thereof is omitted.

As shown in FIG. 9(a), an optical fiber switching mechanism 400 of the receiving system comprises an X axis moving mechanism 402 and an optical connector 403, which are provided on a base 401, a input side optical fiber 404 (hereinafter optical fiber 404) for inputting light to the spectroscope 59, a reference position 405 of movement provided on the base 401 and a motor drive circuit 406.

The optical connector 403 comprises an optical fiber connecting portion 403a on a fixed side and an optical fiber connecting portion 403b on a movable side.

The X axis moving mechanism 402 comprises a ball screw mechanism 402a, a moving table 402b and a stepping motor 402c. On the moving table 402b, the movable side optical fiber connecting portion 403b is mounted and a photo interrupter 405a is provided in the reference position 405 as a reference position detector.

A screw shaft of the ball screw mechanism 402a is rotated by the stepping motor 402c. An encoder 402d for detecting an amount of movement of the movable table 402 is provided on the stepping motor 402c. The stepping motor 402c is driven by the motor drive circuit 406.

An output signal of the encoder 402d and a detection signal of the photo interrupter 405c are respectively inputted to the data processing/control device 7 through the lead lines 407a and 407b and the USB hub 8. The motor drive circuit 406 is connected to the data processing/control device 7 through a lead line 407c and the USB hub 8.

As shown in FIG. 9(b), the fixed side optical fiber connecting portion 403a is fixed on the base 401 and fixedly locates the output ends of the optical fibers 51 and 52 of the light receiving system with a predetermined gap between them. On the other hand, as shown in FIG. 9(c), the movable side optical fiber connecting portion 403b is connected to the input side end portion of the optical fiber 404 on the spectroscope and is movable in the X axis direction. The output side end portion of the optical fiber 404 is coupled to the input port of the spectroscope 59 to input the received light thereto.

Unlike the spectroscope 53, the spectroscope 59 is a usual device having one input port for one optical fiber and a reflective or transmissive diffraction grating provided with the input connector 59a for inputting light to the input port. The spectroscope 59 outputs a spectral analyzing signal to an A/D converter 62 similarly to the spectroscope 53.

The optical fiber switching mechanism 400 of the light receiving system performs the switching under control of the MPU 71, which executes a fiber switching program (not shown) of the light receiving system stored in the memory 72, according to time-divisional switching of the optical fiber switching mechanism 45. Thus, either one of the optical fibers 51 and 52 is optically coupled to the optical fiber 404 selectively.

Moving distance of the movable plate 402b from the reference position 405 to the respective optical fibers 51 and 52 are stored in a parameter region 72e of the memory 72 as the number of drive pulses of the stepping motor 402b.

Moving distances up to the optical fibers 51 and 52 which are stored in the parameter region 72e are measured as follow.

First, in the biochemical measuring device 10, the detection signal of the photo interrupter 405a is received by driving the stepping motor 402b and the movable plate 402b is set in the reference position 405. Then, the micro-channel 92 (first channel) is made in a light irradiating state by driving the fiber switching mechanism 45 of the light system to move the movable plate 405 from the reference position 405 to the optical fiber 51 by driving the stepping motor 402b and the number of drive pulses from the reference position 405 when the detection output of the spectral device 59 is stored in the parameter region 72e. Next, the number of drive pulses for the micro-channel 93 (second channel) is stored in the parameter region 72e, similarly.

Incidentally, when the detection output of the spectroscope 59 becomes maximum, the centers of the optical fibers to be optically coupled coincide mutually.

The receiving light switching between the micro-channel 92 and the micro-channel 93 is achieved by returning the movable table 402b to the reference position 405 once and then moving the movable table 402b to the micro-channel 92 or 93. By this switching, the accumulated error of the positioning for the optical coupling between the optical fiber 404 and the optical fiber 51 or 52 can be avoided.

FIGS. 10(a) to 10(f) show the switch timing of the fiber switching mechanism of the lighting system and the fiber switching mechanism of the receiving system.

FIG. 10(a) shows the lighting switching signal S1. The solenoid drive circuit 46 drives the shutter mechanism 47 by using the rising and falling edges of the lighting switching signal S1 as switching timings. The lighting to the micro-cannel 92 is selected when the signal S1 is in high level (“H”) and the lighting to the micro-channel 93 is selected when the signal S1 is in low level (“L”). Incidentally, the time period of the signal S1 is 3 sec and the lighting period to each channel is 1.5 sec.

FIG. 10(b) shows a receiving light switching signal S2. The stepping motor 402b is driven by the rising and falling edges of the signal S2 used as the switching timings to optically couple the optical fiber 404 to the optical fiber 51 or 52 by returning the movable plate 402b to the reference position 405 once and then moving the stepping motor 402b correspondingly to a predetermined number of pulses. The time period of this operation is the same as that for the lighting switching signal S1. The reflective light from the channel 92 is selected when the signal S2 is in “H” level and the lighting to the channel 93 is selected when the signal S2 is in “L” level.

Incidentally, the time required to set the optical fiber 404 to the optical coupling from the rising or falling edge of the signal S2 is about 0.2 sec. With the timing at which the movement of the movable plate 402b for the optical coupling is completed, the spectroscopic operation start signal AS shown in FIG. 10(c) is generated.

FIG. 10(d) shows the interruption signal In from the controller 61, which indicates a completion of the spectroscopic operation. The interruption signal In is shown by dotted lines because this signal is not always necessary since the spectroscopic processing time is usually 0.2 sec.

FIG. 10(e) shows a data read signal Rd which is sent from the data processing/control device 7 to the controller 61 according to the interruption signal In from the controller 61 or after a predetermined time, for example, 1.1 sec, lapsed from the rising or falling edge of the signal S1. The MPU 71 reads the spectral data DS (FIG. 10(f)) from the memory 63 with the timing of the falling edge of the data read signal Rd.

Although, in this embodiment, the 2 optical fibers of the receiving system are switched correspondingly to the embodiment in FIG. 1, it is possible to perform a 8-channel switching by constructing a 8-channel rotary shutter disk correspondingly to the 8-channel lighting system shown in FIG. 8.

As described hereinbefore, a plurality of optical fibers are used as one bundle in the lighting system and a single optical fiber is used in the receiving system. However, a single optical fiber may constitute the lighting system and plural optical fibers may constitute a bundle in the receiving system.

In the fiber switching mechanism of the lighting system of the described embodiments, the measured data is obtained by the single spectroscope by irradiating the sensor chip 9 with light from either one of the optical fiber bundle 41 (corresponding to the first channel) and the optical fiber bundle 42 (corresponding to the second channel) by switching them alternately with intervals of 1.5 sec. However, the switching interval is not limited to 1.5 sec. In this invention, it is possible to obtain, by one switching operation, a plurality of waveform data by selecting, for example, the optical fiber bundle 41 and then to obtain similar data by switching it to the optical fiber bundle 42.

Further, although the pods of the optical thin film sensor portions, which are connected to the respective micro-channels, are provided in the opposite ends of the channels, it is of course possible to provide a plurality of optical thin film sensor portions for one channel separately from each other.

1. A biochemical measuring device for measuring a coupling of biochemical substances by utilizing optical interference of an optical thin film, comprising:
a sensor chip having a plurality (n) of optical thin film sensor portions, where n is an integer not smaller than 2;
n optical fibers of a lighting system for irradiating said n optical thin film sensor portions with light;
an optical fiber switching mechanism provided midway in said n optical fibers of a lighting system, for selectively passing light from one of said n optical fibers of the lighting system and interrupting light from the remaining optical fibers;
n optical fibers of a receiving system for receiving reflection lights from said n optical thin film sensor portions;
a spectroscope for receiving the reflection lights from said n optical fibers of the receiving system; and
a control portion for controlling said fiber switching mechanism of the lighting system such that light from arbitrary one of said optical fibers is selected,
wherein the reflection light from said optical thin film sensor portions irradiated by the selected optical fiber of the lighting system is analyzed by said spectroscope.

2. A biochemical measuring device as claimed in claim 1, wherein said sensor chip is an n channel sensor chip having a plurality (n) of micro-channels and said optical thin film sensor portions corresponding to said n micro-channels respectively, one of said optical fibers of the lighting system and one of said optical fibers of the receiving system are arranged correspondingly to one of said micro-channels, said control portion controls the switching of said optical fiber switching mechanism of the lighting system time-divisionally, and signals related to wavelength of the reflection lights from said spectroscope are obtained for said n channels time-divisionally.

3. A biochemical measuring device as claimed in claim 2, wherein each said n micro-channels has pods in opposite end portions thereof and said pods are connected to an input port and an output port for feeding liquid.

4. A biochemical measuring device as claimed in claim 3, further comprising a liquid feeding device for feeding biochemical substances as a probes to said n micro-channels of said sensor chip, wherein said sensor chip includes an optical thin film formed by forming a metal thin film on a substrate, said n optical thin film sensor portions are formed on said optical thin film by feeding the biochemical substance to said sensor chip through said pods.

5. A biochemical measuring device as claimed in claim 4, wherein said optical fiber of the lighting system is constituted as a bundle of a plurality of optical fibers, top end portions of said n bundles are located in said n optical thin film sensor portions, respectively, each of said optical fibers of the receiving system is constituted with a single optical fiber, light receiving portion of said n optical fibers of the receiving system are located in center portions of said n bundles at said top end portions.

6. A biochemical measuring device as claimed in claim 4, wherein said spectroscope includes a transmission diffraction grating and a plurality of light receiving elements arranged in a spectral analyzing direction, said n optical fibers of the receiving system has a diameter equal to or smaller than a width of a slit of a light input of said spectroscope and is arranged along a longitudinal direction of said slit and each of said light receiving elements has a predetermined width in a direction orthogonal to the arranging direction of said light receiving elements in order to receive spectrally analyzed light inputted from said n optical fibers of the receiving system.

7. A biochemical measuring device as claimed in claim 4, further comprising a fiber switching mechanism of the receiving system for inputting said receiving light to one of said n optical fibers of the receiving system by selecting the receiving light from said one optical fiber of the receiving system.

8. A biochemical measuring device as claimed in claim 7, wherein said fiber switching mechanism of the receiving system includes an optical connector composed of a first connector member for fixing output side end portions of said n optical fibers of the receiving system and a second connector member for fixing input side end portions of an input side optical fiber for inputting light to said spectroscope and selectively couples one of said n optical fibers of the receiving system to said input side optical fiber by moving said second connector member with respect to said first connector member.

9. A biochemical measuring device as claimed in claim 8, wherein said fiber switching mechanism of the receiving system further includes a single axis moving mechanism for moving said second connector member, said single axis moving mechanism has a reference position and performs the optical coupling by moving said second connection member from said reference position.

10. A biochemical measuring device as claimed in claim 5, wherein said substrate of said sensor chip is a silicon substrate, said optical thin film is formed by forming a silicon nitride on a surface of said silicon substrate and said sensor chips formed by adhering an opposing substrate of light transmissive silicon rubber having said micro-channels are fixed to said silicon substrate.

11. A biochemical measuring device as claimed in claim 10, further comprising a regulation mechanism for regulating a position of said top end portion of said bundle on said respective n optical thin film sensor portions with respect to said respective optical thin film sensor portions of said sensor chip, wherein the top end portions of said respective bundles are regulated by said regulator mechanism according to waveform of the interference spectrum obtained correspondingly to wavelength signal obtained by said spectroscope to which buffer liquid for diluting a sample is supplied by said light feeding device.

12. A biochemical measuring device as claimed in claim 11, further comprising a chip cover provided on said sensor chip, wherein said chip cover has said input port and said output port and is put on said sensor chip and, when said chip cover is put on said sensor chip, said input port and said output port communicate with said pods, respectively.
